(19) United States
(12) Patent Application Publication
(10) Pub. No.: US 2026/0291361 A1
(43) Pub. Date: Sep. 24, 2026

(54) POWER CONVERSION DEVICE AND CONTROL DEVICE FOR POWER CONVERTER

(71) Applicant: MITSUBISHI ELECTRIC CORPORATION, Tokyo (JP)

(72) Inventors: Takuya KATAOKA, Chiyoda-ku, Tokyo (JP); Yosuke SHINOMOTO, Chiyoda-ku, Tokyo (JP)

(73) Assignee: MITSUBISHI ELECTRIC CORPORATION, Tokyo (JP)

(21) Appl. No.: 19/477,498

(22) PCT Filed: May 31, 2023
(86) PCT No.: PCT/JP2023/020260

§ 371 Date: Oct. 22, 2025

(51) Int. Cl. H02M 1/00; H02M 1/088; H02M 1/44

(52) U.S. Cl. CPC H02M 1/0009; H02M 1/0054; H02M 1/088; H02M 1/44

(57) ABSTRACT

A control device for a power converter includes a current sensor, a plurality of semiconductor driving units, and a main controller. Each of the plurality of semiconductor driving units is provided for a corresponding switching element of a plurality of switching elements included in the power converter, and adjusts a switching speed of the corresponding switching element in accordance with a corresponding drive capability adjustment signal. The main controller outputs a drive signal for controlling timing of switching to each of the plurality of switching elements based on a value of current detection by the current sensor. The main controller generates, for each of the semiconductor driving units, the corresponding drive capability adjustment signal based on relation between timing of switching of the corresponding switching element and timing of current detection by the current sensor.

### TECHNICAL FIELD

The present disclosure relates to a power conversion device and a control device for a power converter.

### BACKGROUND ART

In an inverter device of a single-shunt current detection type, in order to reconstruct a three-phase current based on a current that flows through a direct-current (DC) bus, the current should be detected in two different switching states for each cycle of a pulse width modulation (PWM) carrier. In this case, since detection of the current immediately after switching is accompanied by an error, the current through the DC bus is detected after lapse of a stand-by time period T_{MIN} since switching.

Japanese Patent Laying-Open No. 11-4594 (PTL 1) discloses measures when at least one of two components of an output voltage vector Vs is less than a stand-by time period T_{MIN}. Specifically, the inverter device in this literature includes means for calculating a vector Vs′ each of two components of which is at least equal to stand-by time period T_{MIN} and a vector Vs″ such that a vectorial average of these vectors Vs′ and Vs″ is equal to output voltage vector Vs.

### CITATION LIST

### Patent Literature

PTL 1: Japanese Patent Laying-Open No. 11-4594

### SUMMARY OF INVENTION

### Technical Problem

With the method in PTL 1 above, however, when an original output voltage command is within an overmodulation region, vector Vs′ and vector Vs″ may not be generated such that the vectorial average of vectors Vs′ and Vs″ is equal to output voltage vector Vs.

The present disclosure was made in consideration of the problem above, and one of objects thereof is to provide a control device for a power converter to detect a current with a stand-by time period after switching being as short as possible.

### Solution to Problem

A control device for a power converter in one embodiment is provided. The power converter includes a plurality of switching elements, the power converter converting power by switching of the plurality of switching elements. The control device includes a current sensor, a plurality of semiconductor driving units, and a main controller. The current sensor is provided to detect a current that flows through the plurality of switching elements. Each of the plurality of semiconductor driving units is provided for a corresponding switching element of the plurality of switching elements and adjusts a switching speed of the corresponding switching element in accordance with a corresponding drive capability adjustment signal. The main controller outputs a drive signal for controlling timing of switching to each of the plurality of switching elements based on a value of current detection by the current sensor, The main controller generates, for each of the semiconductor driving units, the corresponding drive capability adjustment signal based on relation between timing of switching of the corresponding switching element and timing of current detection by the current sensor.

### Advantageous Effects of Invention

According to the embodiment above, the corresponding drive capability adjustment signal is generated for each of the semiconductor driving units based on relation between timing of switching of the corresponding switching element and timing of current detection by the current sensor, so as to adjust the switching speed of the corresponding switching element. The current can thus be detected, with a stand-by time period after switching being as short as possible.

### BRIEF DESCRIPTION OF DRAWINGS

FIG. 1 is a circuit diagram showing an exemplary configuration of a power conversion device according to a first embodiment.

FIG. 2 is a block diagram showing an exemplary configuration of a main controller in FIG. 1,

FIG. 3 is a diagram showing an exemplary configuration of a semiconductor driving unit in FIG. 1.

FIG. 4 is a diagram showing exemplary change of a switching waveform in accordance with whether or not drive capability is adjusted.

FIG. 5 is a timing chart showing an exemplary operation of the main controller in FIG. 2.

FIG. 6 is a diagram for illustrating a switching state of a main circuit corresponding to a drive signal in FIG. 5.

FIG. 7 is a timing chart showing another exemplary operation of the main controller in FIG. 2.

FIG. 8 is a timing chart showing a control operation in a comparative example.

FIG. 9 is a timing chart showing an exemplary operation of the main controller in the power conversion device in a second embodiment.

FIG. 10 is a flowchart showing an operation of a drive capability adjuster in the power conversion device in the second embodiment.

FIG. 11 is a block diagram showing an exemplary configuration of a main controller in the inverter device as the power conversion device in a third embodiment.

FIG. 12 is a timing chart showing an exemplary operation of the main controller in FIG. 11.

FIG. 13 is a flowchart showing operations by the drive capability adjuster and a drive signal generator in the power conversion device in the third embodiment.

### DESCRIPTION OF EMBODIMENTS

Each embodiment will be described in detail below with reference to the drawings. Though an inverter device of a single-shunt current detection type will be described below by way of example, a power conversion device in the present disclosure is not limited to the inverter device and the current detection type is not limited to the single-shunt type but may be another current detection type such as a 3-shunt type. The same or corresponding elements have the same reference characters allotted and description thereof will not be repeated.

### First Embodiment

### Overall Configuration of Power Conversion Device

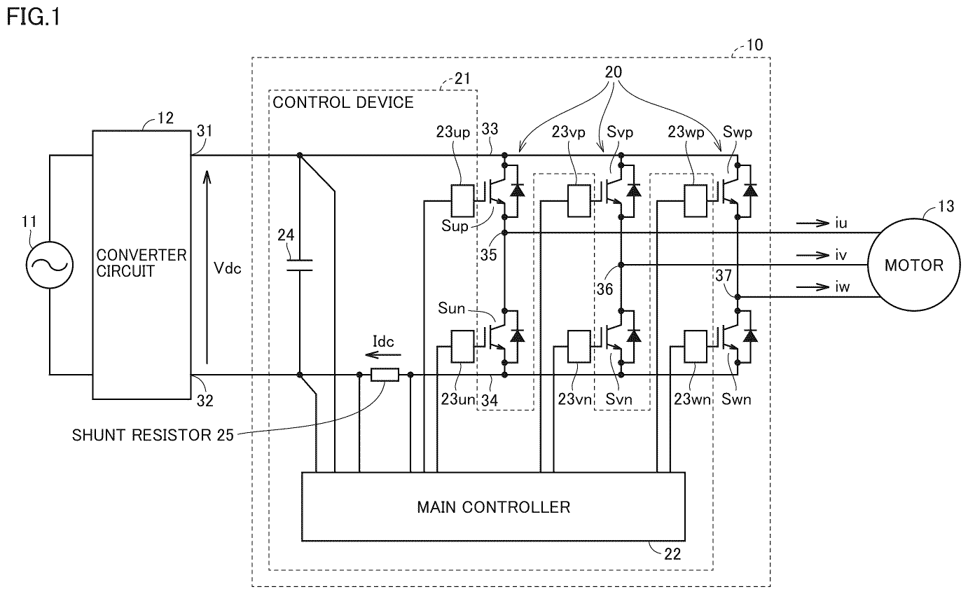

FIG. 1 is a circuit diagram showing an exemplary configuration of a power conversion device according to a first embodiment. FIG. 1 shows an inverter device 10 to drive a three-phase motor 13 as an example of the power conversion device.

Furthermore, FIG. 1 shows an alternating-current (AC) power supply 11 representing an AC system and a converter circuit 12 as an exemplary configuration for supply of a DC voltage Vdc to inverter device 10. Converter circuit 12 converts AC power received from the AC system into DC power. A high-potential-side DC bus 33 is connected to a high-potential-side output node 31 of converter circuit 12 and a low-potential-side DC bus 34 is connected to a low-potential-side output node 32 of converter circuit 12.

Instead of AC power supply 11 and converter circuit 12, a DC power supply such as a rechargeable battery and a solar cell may be employed. A DC/DC converter may further be provided between the DC power supply and inverter device 10.

Inverter device 10 as the power conversion device includes a main circuit 20 and a control device 21 to control main circuit 20. In the present disclosure, main circuit 20 is also referred to as a power converter or an inverter circuit.

Main circuit 20 converts DC power supplied through DC bus 33, 34 into AC power by switching of a plurality of switching elements Sup, Svp, Swp, Sun, Svn, and Swn (denoted as a switching element S when they are collectively referred to). Main circuit 20 drives motor 13 by supplying resultant AC power thereto.

More specifically, main circuit 20 includes switching element Sup in a U-phase upper arm, switching element Sun in a U-phase lower arm, switching element Svp in a V-phase upper arm, switching element Svn in a V-phase lower arm, switching element Swp in a W-phase upper arm, and switching element Swn on a low potential side in a W-phase lower arm. Switching element Sup is connected between high-potential-side DC bus 33 and a U-phase output node 35. Switching element Sun is connected between low-potential-side DC bus 34 and U-phase output node 35. Switching element Svp is connected between high-potential-side DC bus 33 and a V-phase output node 36. Switching element Svn is connected between low-potential-side DC bus 34 and V-phase output node 36. Switching element Swp is connected between high-potential-side DC bus 33 and a W-phase output node 37. A U-phase current iu, a V-phase current iv, and a W-phase current iw are outputted from U-phase output node 35, V-phase output node 36, and W-phase output node 37 to motor 13, respectively.

Though FIG. 1 illustrates an insulated gate bipolar transistor (IGBT) as switching element S, limitation thereto is not intended. For example, a power metal-oxide-semiconductor field effect transistor (MOSFET) or a bipolar power transistor may be employed as switching element S.

Control device 21 includes a main controller 22, semiconductor driving units 23up, 23un, 23vp, 23vn, 23wp, and 23wn, a DC capacitor 24, and a shunt resistor 25. When semiconductor driving units 23up, 23un, 23vp, 23vn, 23wp, and 23wn are collectively referred to or any one of them is referred to in the description below, denotation as semiconductor driving unit 23 is given.

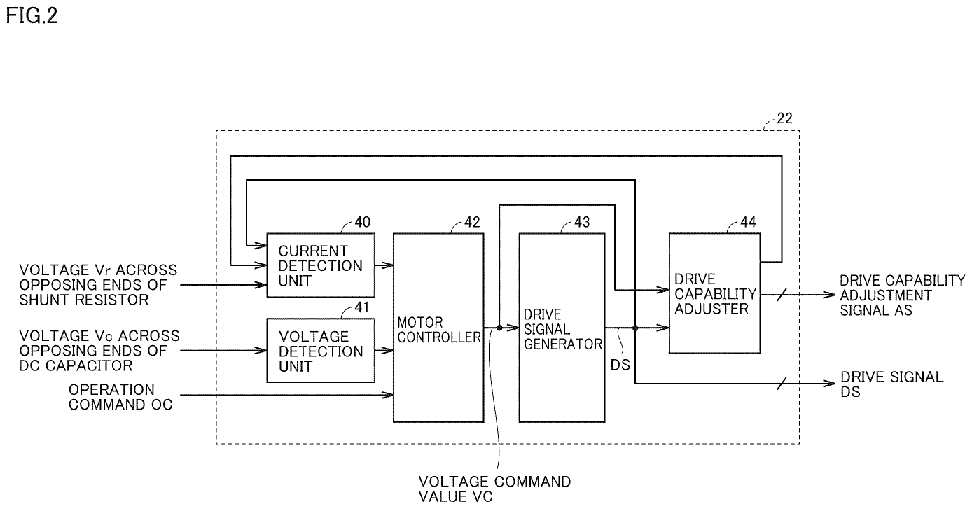

Main controller 22 outputs a drive signal (which is also referred to as a gate signal) and a drive capability adjustment signal for controlling main circuit 20, based on a DC current value or the like detected by shunt resistor 25. A more detailed exemplary configuration of main controller 22 will be described later with reference to FIG. 2.

DC capacitor 24 is connected between high-potential-side output node 31 and low-potential-side output node 32 of converter circuit 12. DC voltage Vdc across opposing ends of DC capacitor 24 is taken into main controller 22.

Shunt resistor 25 as a current sensor detects a current that flows through DC bus 33 or 34. Though shunt resistor 25 is provided in low-potential-side DC bus 34 in FIG. 1, it may be provided in high-potential-side DC bus 33. A voltage across opposing ends of shunt resistor 25 is taken into main controller 22. A current transformer (CT) including a Hall element may be employed as a current detector instead of shunt resistor 25, and a type of the current sensor is not particularly limited.

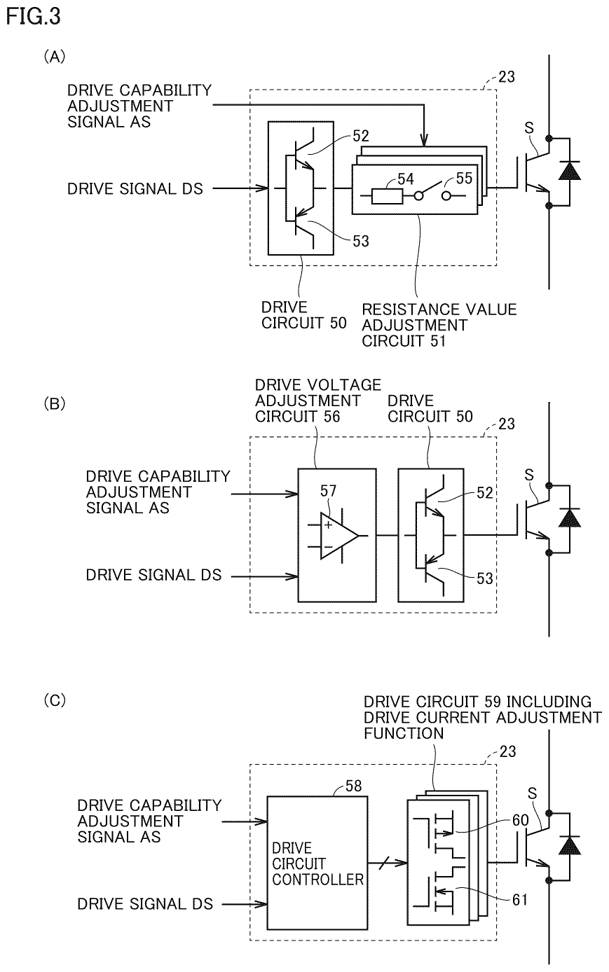

Semiconductor driving units 23up, 23un, 23vp, 23vn, 23wp, and 23wn are provided in correspondence with respective switching elements Sup, Sun, Svp, Svn, Swp, and Swn. Each semiconductor driving unit 23 controls timing to open and close corresponding switching element S and adjusts drive capability based on a gate signal and a drive capability adjustment signal individually inputted from main controller 22. An exemplary configuration of semiconductor driving unit 23 will be described later with reference to FIG. 3.

### Exemplary Configuration and Operation of Main Controller

FIG. 2 is a block diagram showing an exemplary configuration of main controller 22 in FIG. 1. As shown in FIG. 2, main controller 22 includes a current detection unit 40, a voltage detection unit 41, a motor controller 42, a drive signal generator 43, and a drive capability adjuster 44.

Current detection unit 40 and voltage detection unit 41 each include an analog-to-digital (AD) conversion circuit, a buffer circuit, a filter circuit, and the like.

Motor controller 42, drive signal generator 43, and drive capability adjuster 44 are configured, for example, with a microcomputer including a CPU and a memory and combination of hardware such as a field programmable gate array (FPGA) and software (a program). Alternatively, at least one of them may be configured with a logic circuit such as an application specific integrated circuit (ASIC). A function of each constituent element will be described below.

Current detection unit 40 detects a DC current Ide that flows through low-potential-side DC bus 34 based on a voltage Vr across opposing ends of shunt resistor 25. Details of a single-shunt current detection technique will be described later.

Voltage detection unit 41 detects DC voltage Vdc inputted to inverter device 10 based on a voltage Ve across opposing ends of DC capacitor 24.

Motor controller 42 generates a command value VC for a voltage to be applied to motor 13 based on information detected by current detection unit 40 and voltage detection unit 41 and an operation command OC such as a set rotation speed command value. For example, motor controller 42 estimates an operating state such as a rotation speed of motor 13 with known sensorless speed control and generates voltage command value VC based on the estimated operating state.

Drive signal generator 43 generates a drive signal DS (which is also referred to as a gate signal) for controlling on and off of each switching element S included in main circuit 20 of inverter device 10, based on voltage command value VC.

In the first embodiment, drive signal generator 43 generates drive signal DS under PWM control based on comparison between a triangular wave carrier signal and voltage command value VC. Drive signal DS to be outputted to each switching element S may be generated with another method such as a space vector method, without using the triangular wave carrier signal.

Voltage command value VC is often updated every constant control cycle (for example, timing of a peak or a valley or the like of the triangular wave carrier signal). Therefore, at timing of update of voltage command value VC, drive signal generator 43 and drive capability adjuster 44 can calculate in advance timing of on and off of the gate signal in one cycle of a next carrier signal and durations of an on time period and an off time period.

Drive capability adjuster 44 generates a drive capability adjustment signal AS (which is simply also referred to as an adjustment signal) for adjusting a switching speed of each switching element S based on voltage command value VC and drive signal DS. Drive capability adjuster 44 outputs generated drive capability adjustment signal AS to semiconductor driving unit 23 corresponding to each switching element S. Each switching element S changes its switching speed in accordance with drive capability adjustment signal AS.

### One-Shunt Current Detection Technique

The single-shunt current detection technique will be described below. In inverter device 10 to drive motor 13, in order to eliminate a three-phase current sensor connected to an output end, a single-shunt type is employed. In the single-shunt type, a value of a three-phase AC current outputted from inverter device 10 is reconstructed based on a result of measurement of the DC current detected by shunt resistor 25 connected to DC bus 33 or 34.

In this single-shunt type, in order to reconstruct the three-phase output current, a DC current value is detected in at least two switching states every PWM cycle. At this time, a stand-by time period T_{MIN} is provided after switching of an output state of main circuit 20 by switching of the plurality of switching elements S and before actual detection of the current. This stand-by time period T_{MIN} is necessary for securing a sample-and-hold time period for an AD conversion circuit and a dead time and further for avoiding such influence as ringing involved with switching or control delay. Specifically, stand-by time period T_{MIN} is often set for each drive capability of the switching element based on a result of tests or calculation performed in advance. Since a recovery current and a surge voltage are dependent on magnitude of the output current, stand-by time period T_{MIN} may be set or switched further based on information on the output current.

Current detection unit 40 in the present embodiment detects in a predetermined switching state, the DC current after lapse of the stand-by time period since switching to that switching state. The switching state is distinguished based on drive signal DS generated by drive signal generator 43. Furthermore, current detection unit 40 reconstructs the output current of each phase from inverter device 10, based on the detected DC current value and drive signal DS. A value set in advance may be employed as stand-by time period T_{MIN}, or switching to a value designated by drive capability adjuster 44 may be made.

In the single-shunt current detection technique as above, stand-by time period T_{MIN} is necessary in principle. Therefore, in an example where a voltage vector is outputted only for a period shorter than stand-by time period T_{MIN}, disadvantageously, the current cannot be detected. Consequently, a period during which the current cannot be detected is produced also in a normal operation. In particular, at a low modulation factor at which an output voltage from the inverter is low or an overmodulation factor at which the output voltage is high, influence by stand-by time period T_{MIN} is great and hence the current can hardly be detected. Thus, control response of motor 13 is restricted as exemplified by possibility of instability in control of motor 13.

As will be described later in detail, in inverter device 10 in the present embodiment, drive capability adjuster 44 can adjust the switching speed of each switching element S to suppress influence or the like by ringing and to reduce stand-by time period T_{MIN}. Controllability of motor 13 can thus be improved and an operation range of motor 13 can be larger.

### Exemplary Configuration and Operation of Semiconductor Driving Unit

FIG. 3 is a diagram showing an exemplary configuration of semiconductor driving unit 23 in FIG. 1. FIG. 3 shows three exemplary methods for adjusting the switching speed of switching element S. Any method may be employed without being limited to three examples below, so long as the switching speed can be adjusted therewith.

Specifically, referring to FIG. 3(A), semiconductor driving unit 23 includes a drive circuit 50 and a plurality of resistance value adjustment circuits 51. Drive circuit 50 includes an NPN-type bipolar transistor 52 and a PNP-type bipolar transistor 53 connected in series between a power supply node (not shown) and a ground (not shown). Drive signal DS is inputted to a gate of bipolar transistor 52, 53.

The plurality of resistance value adjustment circuits 51 are connected in parallel between a connection node of bipolar transistors 52 and 53 and a gate of switching element S. Each resistance value adjustment circuit 51 includes a resistive element 54 and a switch 55 connected in series. On and off of switch 55 of each resistance value adjustment circuit 51 is controlled by drive capability adjustment signal AS. A gate resistance value of switching element S can be changed by switching between on and off of each switch 55, to thereby adjust the switching speed of switching element S.

Referring to FIG. 3(B), semiconductor driving unit 23 includes a drive voltage adjustment circuit 56 and drive circuit 50. The configuration of drive circuit 50 is similar to that in FIG. 3(A). In drive circuit 50, the connection node of bipolar transistors 52 and 53 is connected to the gate of switching element S. Drive signal DS amplified by a voltage amplifier 57 (for example, an operational amplifier circuit) included in drive voltage adjustment circuit 56 is inputted to the gate of bipolar transistor 52, 53. An amplification factor of voltage amplifier 57 can be adjusted in accordance with drive capability adjustment signal AS. Since a gate voltage at the time of switching between on and off of bipolar transistor 52, 53 can thus be adjusted, the switching speed of switching element S can be adjusted.

Referring to FIG. 3(C), semiconductor driving unit 23 includes a drive circuit controller 58 and a plurality of drive circuits 59 connected in parallel. Each drive circuit 59 includes an enhancement type P-channel MOSFET 60 connected between the power supply node (not shown) and the gate of switching element S and an enhancement type N-channel MOSFET 61 connected between the gate of switching element S and the ground (not shown).

Drive circuit controller 58 supplies drive signal DS to a gate of MOSFET 60, 61 included in drive circuit 59 selected in accordance with drive capability adjustment signal AS. Since the number of MOSFETs connected in parallel to be turned on can thus be changed in accordance with drive capability adjustment signal AS, a drive current for charging and discharging of the gate of switching element S can be adjusted. Consequently, the switching speed of switching element S can be adjusted.

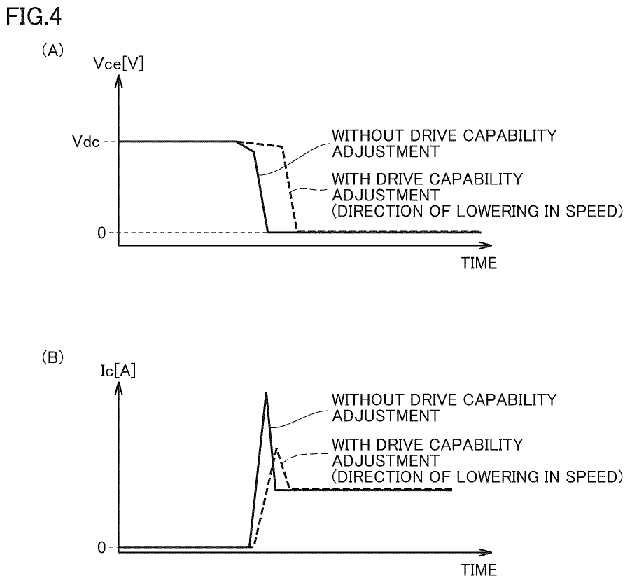

FIG. 4 is a diagram showing exemplary change of a switching waveform in accordance with whether or not drive capability is adjusted. FIG. 4(A) shows a waveform of a collector-emitter voltage Vce at the time of turn-on and FIG. 4(B) shows a waveform of a collector current Ic at the time of turn-on. FIG. 4(A), (B) shows a waveform without drive capability adjustment with a solid line and shows a waveform with drive capability adjustment with a dashed line.

Referring to FIG. 4(A), by adjusting drive capability to lower the switching speed of switching element S, timing of lowering in collector-emitter voltage Vce from supply voltage Vdc to a zero voltage is delayed.

Referring to FIG. 4(B), by adjusting drive capability to lower the switching speed of switching element S, a rate of variation in collector current Ic at the time of turn-on is lowered and overshoot due to a recovery current is suppressed.

Though FIGS. 4(A) and (B) shows overshoot of the current due to the recovery current, it does not show an oscillating component. In an actual circuit, a switching waveform often includes an oscillating component.

Specifically, LC resonance based on a capacitive component and an inductive component in a loop formed by DC buses 33 and 34, DC capacitor 24, switching element S, and shunt resistor 25 is excited by the recovery current at the time of switching and change (commutation) of a current path at the time of turn-off of switching element S. An oscillation waveform based on this LC resonance is then included in the switching waveform as ringing.

Since the capacitive component and the inductive component in the loop are determined by a circuit that is configured, the inductive component or the like of certain magnitude is produced due to such restrictions as an insulation distance and a physical distance such as a size of a component. Therefore, in order to reduce the oscillating component, energy that causes ringing, such as the recovery current and commutation of the current, should be lowered.

It has generally been known that the recovery current is lowered by lowering of a turn-on speed in corresponding switching at the time of production of the recovery current. In addition, excitation of oscillation in the circuit loop including a shunt resistor can be suppressed by reduction of variation in current at the time of turn-off, that is, a speed of turn-on. In other words, when there is a concern about adverse influence by ringing, the influence by ringing can be suppressed by temporary lowering of the switching speed at the time of both of turn-on and turn-off of switching element S. Consequently, stand-by time period T_{MIN} in single-shunt current detection can be reduced. Since lowering of the switching speed leads to aggravation of switching loss, switching elements drive capability of which is to be changed are desirably as few as possible.

### Details of Operation of Main Controller 22

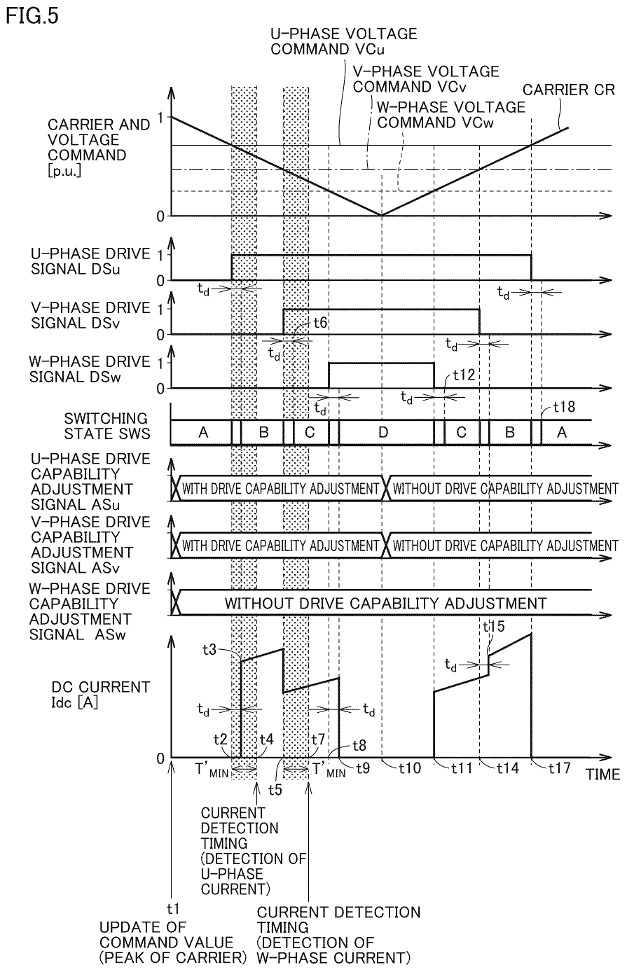

FIG. 5 is a timing chart showing an exemplary operation of main controller 22 in FIG. 2. FIG. 5 shows drive signals DSu, DSv, and DSw of respective phases (denoted as drive signal DS when they are collectively referred to) in one cycle of a PWM carrier signal, a switching state SWS, drive capability adjustment signals ASu, ASv, and ASw of respective phases (denoted as drive capability adjustment signal AS when they are collectively referred to), a waveform of DC current Idc, and current detection timing.

Motor controller 42 and drive signal generator 43 of main controller 22 update command values such as voltage command value VC and drive signal DS every control cycle equal to a cycle of a triangular wave carrier signal CR, based on a voltage value and a current value detected so far. Specifically, in FIG. 5, main controller 22 updates the command value at a peak (time t1) of carrier signal CR.

Drive signal generator 43 generates drive signal DS of each phase based on comparison between voltage command value VC of each phase and carrier signal CR. Specifically, in FIG. 5, since a U-phase voltage command value VCu is larger than carrier signal CR during a period from time t2 until time t17, U-phase drive signal DSu is at the high level (“1”), and U-phase drive signal DSu is at the low level (“0”) during other periods in the figure. Similarly, during a period from time t5 until time t14, V-phase drive signal DSv is at the high level (“1”), and during a period from time t8 until time t11, W-phase drive signal DSw is at the high level (“1”).

In the present embodiment, basically, while drive signal DS is at the high level (“1”), switching element S in the upper arm is on and switching element S in the lower arm is off. While drive signal DS is at the low level (“0”), switching element S in the upper arm is off and switching element S in the lower arm is on.

Drive signals DSu, DSv, and DSw are drive signals before the dead time is given. In switching between on and off, the dead time in which switching elements S in both of the upper and lower arms are off is provided. Specifically, in FIG. 5, each of periods from time t2 to time t3, from time t5 to time t6, from time t8 to time t9, from time t11 to time t12, from time t14 to time t15, and from time t17 to time t18 is the dead time.

The drive signals after the dead time is given are as follows. A drive signal DSup for switching element Sup in the U-phase upper arm is at the high level during a period from time t3 to time t17 and at the low level during other periods in FIG. 1. A drive signal DSun for switching element Sun in the U-phase lower arm is at the low level during a period from time t2 until time t18 and at the high level during other periods in FIG. 5.

Similarly, a drive signal DSvp for switching element Svp in the V-phase upper arm is at the high level during a period from time t6 to time t14 and at the low level during other periods in FIG. 1. A drive signal DSvn for switching element Svn in the V-phase lower arm is at the low level during a period from time t5 until time t15 and at the high level during other periods in FIG. 5.

Similarly, a drive signal DSwp for switching element Swp in the W-phase upper arm is at the high level during a period from time t9 to time t11 and at the low level during other periods in FIG. 1. A drive signal DSwn for switching element Swn in the W-phase lower arm is at the low level during a period from time t8 until time t12 and at the high level during other periods in FIG. 5.

While each of the drive signal for the upper arm and the drive signal for the lower arm of each phase is at the high level, corresponding switching element S is on, and while it is at the low level, corresponding switching element S is off.

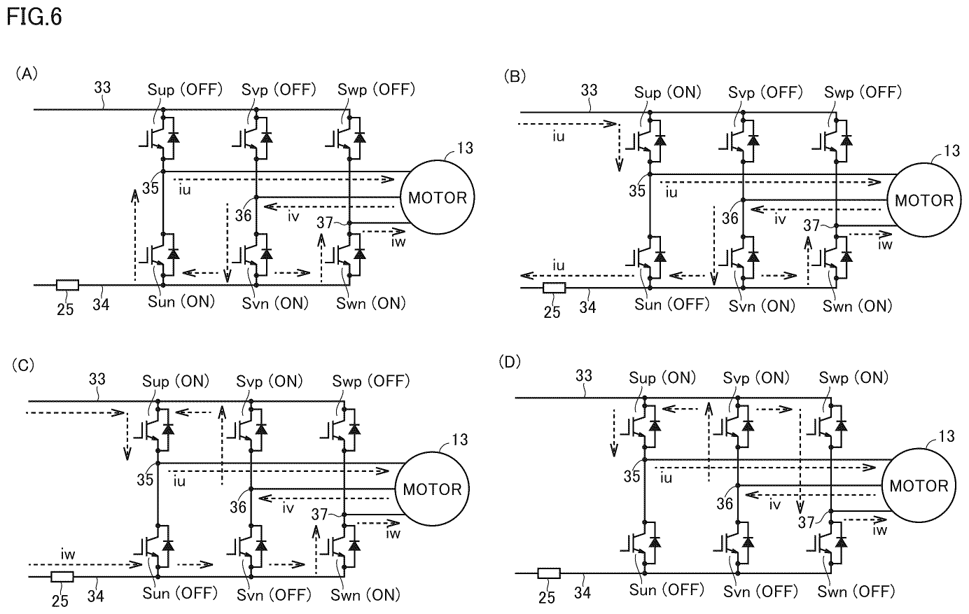

FIG. 6 is a diagram for illustrating a switching state of main circuit 20 corresponding to drive signal DS in FIG. 5. Furthermore, FIG. 6 shows a current path corresponding to each switching state. U-phase output current iu and W-phase output current iw are defined as positive and V-phase output current iv is defined as negative. An output current in a direction from inverter device 10 toward motor 13 is defined as positive.

There are four switching states SWS from A to D, of main circuit 20 of inverter device 10 corresponding to each drive signal DS in FIG. 5. Referring to FIG. 6(A), in a switching state A (from time t1 to t2, and after time t18 in FIG. 5), switching elements Sup, Svp, and Swp in the upper arms of the U-phase, the V phase, and the W phase are off, and switching elements Sun, Svn, and Swn in the lower arms of the U-phase, the V phase, and the W phase are on. In this case, no current flows to shunt resistor 25.

Referring to FIG. 6(B), in a switching state B (from time t3 to t5 and from time t15 to t17 in FIG. 5), switching element Sup in the U-phase upper arm is on and switching element Sun in the U-phase lower arm is off. On the other hand, switching elements Svp and Swp in the upper arms of the V phase and the W phase are off, and switching elements Svn and Swn in the lower arms of the V phase and the W phase are on. In this case, U-phase current iu flows to shunt resistor 25.

Referring to FIG. 6(C), in a switching state C (from time t6 to 18 and from time t12 to t14 in FIG. 5), switching elements Sup and Svp in the upper arms of the U phase and the V phase are on and switching elements Sun and Svn in the lower arms of the U phase and the V phase are off. On the other hand, switching element Swp in the W-phase upper arm is off and switching element Swn in the W-phase lower arm is on. In this case, W-phase current iw flows to shunt resistor 25.

Referring to FIG. 6(D), in a switching state D (from time t8 to t11 in FIG. 5), switching elements Sup, Svp, and Swp in the upper arms of the U phase, the V phase, and the W phase are on and switching elements Sun, Svn, and Swn in the lower arms of the U phase, the V phase, and the W phase are off. In this case, no current flows to shunt resistor 25.

Therefore, U-phase current iu can be detected in switching state B and W-phase current iw can be detected in switching state C. V-phase current iv can be obtained by calculation based on relation of iu+iv+iw=0. The three-phase output current can be reconstructed based on the currents detected in the plurality of switching states.

Referring again to FIG. 5, drive capability adjustment unit 44 determines drive capability of which switching element S it adjusts within an adjustment period, based on timing of switching of each switching element S estimated at the time of update of voltage command value VC. In FIG. 5, the period for adjustment of drive capability is set within a falling period of carrier signal CR (that is, a half cycle of carrier signal CR from time t1 until time t10). Alternatively, the adjustment period may be set in association with carrier signal CR, such as a rising period of carrier signal CR, or the adjustment period may be set in association with some operation, such as a certain period having current detection timing as an end point.

In the example shown in FIG. 5, at the time of switching of the upper and lower arms of the U phase made immediately before detection of the U-phase current at time t4 and switching of the upper and lower arms of the V phase made immediately before detection of the W-phase current at time t7, drive capability is adjusted to set the switching speed to be lower than an initially set normal value. Drive capability is not adjusted when the current is detected after switching (specifically, switching of W-phase upper and lower arms and switching in a latter half cycle of carrier signal CR).

A stand-by time period T′_{MIN} is set to be shorter than a normal stand-by time period T_{MIN} on the premise that the switching speed is set to be lower than a normal switching speed. A specific value of stand-by time period T′_{MIN} is set based on a result of tests or calculation performed in advance.

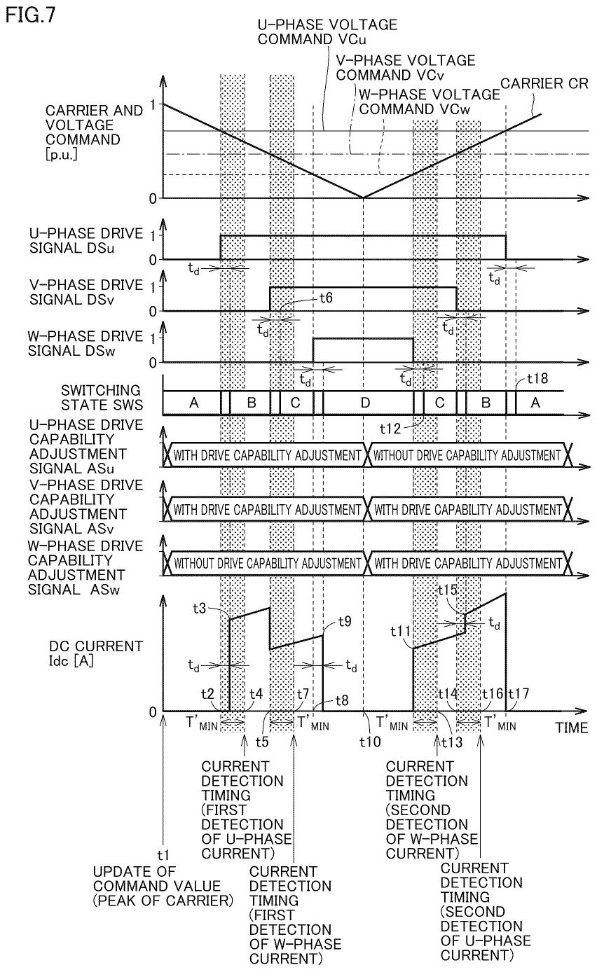

FIG. 7 is a timing chart showing another exemplary operation of main controller 22 in FIG. 2. The timing chart in FIG. 7 corresponds to the timing chart in FIG. 5, and shows drive signal DS of each phase in one cycle of a carrier, switching state SWS, drive capability adjustment signal AS of each phase, a waveform of DC current Idc, and current detection timing.

A control operation in FIG. 7 is different from that in FIG. 5 in that the W-phase current is detected also at time t13 in addition to time t7 and the U-phase current is detected also at time t16 in addition to time t4, Therefore, each of a former half and a latter half of one cycle of carrier signal CR is set as the period for adjustment of drive capability.

Specifically, in switching of U-phase upper and lower arms made immediately before detection of the U-phase current at time t4, switching of V-phase upper and lower arms made immediately before detection of the W-phase current at time t7, switching of the W-phase upper and lower arms made immediately before detection of the W-phase current at time t13, and switching of the V-phase upper and lower arms made immediately before detection of the U-phase current at time t16, drive capability adjustment to set the switching speed to be lower than a normal switching speed is made. The stand-by time period is set to stand-by time period T′_{MIN} shorter than initially set normal stand-by time period T_{MIN} on the premise that the switching speed is set to be lower than the normal switching speed. In an example where the current is not detected after switching (specifically, switching of the W-phase upper and lower arms at time t8, 19 and switching of the U-phase upper and lower arms at time t17, t18), drive capability is not adjusted.

Since FIG. 7 is otherwise similar to FIG. 5, identical or corresponding elements have identical reference characters allotted and description thereof will not be repeated.

Thus, in consideration of influence by a current ripple caused by switching, the number of times of current detection may be increased from two to four per one cycle of carrier signal CR. Alternatively, the number of times of adjustment of the switching speed may be varied depending on the number of times and a method of current detection.

### Effect of First Embodiment

In inverter device 10 as the power conversion device in the first embodiment, a corresponding drive capability adjustment signal is adjusted for each semiconductor driving unit 23, based on relation between timing of switching of corresponding switching element S and timing of current detection by current sensor 25. Influence by ringing due to a switching operation immediately before current detection is thus suppressed by switching of the switching speed. Furthermore, since stand-by time period T_{MIN} from switching immediately before detection of electric power until current detection can be reduced, an operation range where the current can be detected can be larger and consequently control characteristics of the motor can be improved.

In the first embodiment, in adjustment of drive capability of switching element S, drive capability is adjusted to lower the switching speed, however, drive capability can also be adjusted in a reverse manner. For example, in an example where the inductive component and the capacitive component of the circuit loop including the shunt resistor are low and ringing hardly occurs, drive capability may be adjusted to increase the switching speed and the dead time may be reduced so as to reduce stand-by time period T_{MIN}. An example where the switching speed is increased will be described in a third embodiment.

### Second Embodiment

In a second embodiment, an example in which switching between making drive capability adjustment and change of stand-by time period T_{MIN} and not making the same is made will be described. A comparative example where neither of drive capability adjustment and change of stand-by time period T_{MIN} is made will initially be described below, and an operation of the main controller of the power conversion device in the present embodiment will then be described as compared with the comparative example.

Since the second embodiment is similar in hardware configuration of the power conversion device (for example, the inverter device) to the first embodiment described with reference to FIGS. 1 to 4, description will not be repeated.

### Operation of Main Controller in Comparative Example

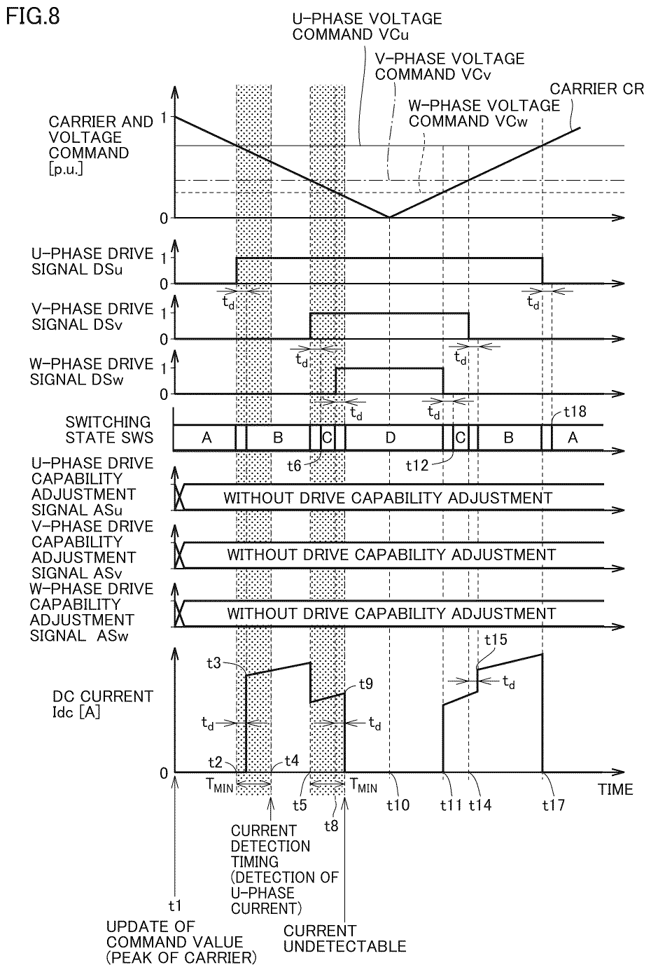

FIG. 8 is a timing chart showing a control operation in the comparative example. The timing chart in FIG. 8 corresponds to the timing chart in FIG. 5, and shows drive signal DS of each phase in one cycle of a carrier, switching state SWS, drive capability adjustment signal AS of each phase, a waveform of a DC current, and current detection timing.

The control operation in FIG. 8 is different from that in FIG. 5 in that normal stand-by time period T_{MIN} is used as the stand-by time period until current detection and drive capability is adjusted in no switching. Furthermore, in the control operation in FIG. 8, a period between switching in the V phase and switching in the W phase (that is, switching state C) is shorter than that in FIG. 5. Since FIG. 8 is otherwise similar to FIG. 5, identical or corresponding elements have identical reference characters allotted and description thereof will not be repeated.

As shown in FIG. 8, U-phase current detection timing (time t4) is within a period of switching state B (from time t3 until t5). Therefore, the U-phase current can be detected without change of stand-by time period T_{MIN} and adjustment of drive capability. Next switching in the W phase, on the other hand, occurs during stand-by period T_{MIN} before W-phase current detection timing, and hence the W-phase current cannot be detected. Therefore, in order to detect the W-phase current, the stand-by time period should be changed to shorter T′_{MIN} and drive capability adjustment for lowering the switching speed for suppressing ringing at the time of switching should be made.

### Operation of Main Controller in Present Embodiment

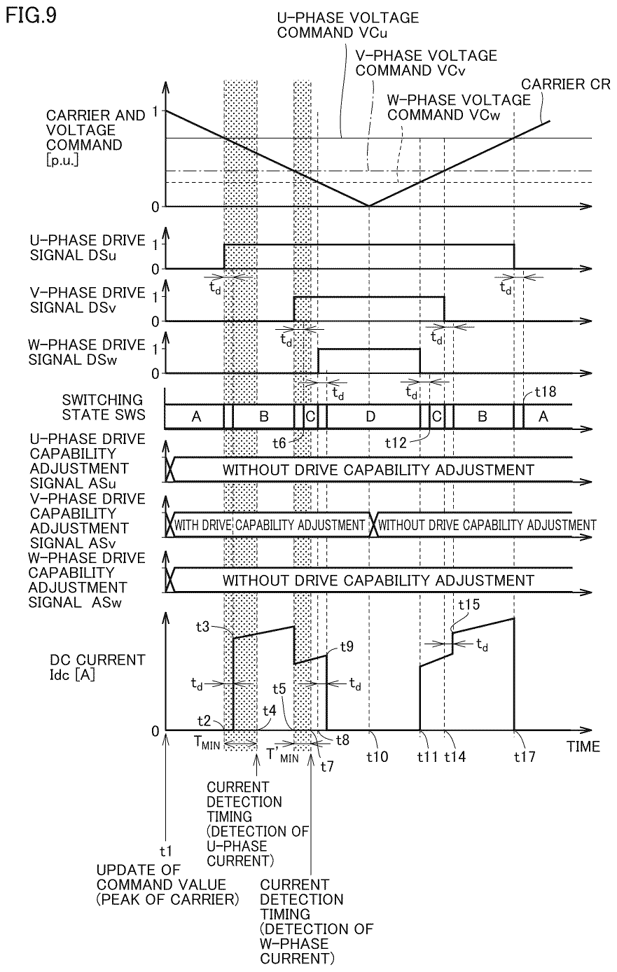

FIG. 9 is a timing chart showing an exemplary operation of the main controller in the power conversion device in the second embodiment. Though the timing chart in FIG. 9 corresponds to the timing chart in FIG. 8, it is different from the timing chart in FIG. 8 in that the stand-by time period before W-phase current detection is changed to shorter T′_{MIN} and drive capability adjustment to lower the switching speed in switching of the V-phase upper and lower arms immediately before W-phase current detection timing at time t7 is made. Since the W-phase current detection timing (time t7) is consequently within a period of switching state C (from time t6 until t8), the W-phase current can be detected.

The stand-by time period before U-phase current detection timing (time t4), on the other hand, remains at initially set normal stand-by time period T_{MIN}. Drive capability is not adjusted in switching in the U phase immediately before current detection timing (time t4). Since the current can thus be detected without drive capability adjustment, unnecessary increase in switching loss due to lowering in switching speed can be prevented.

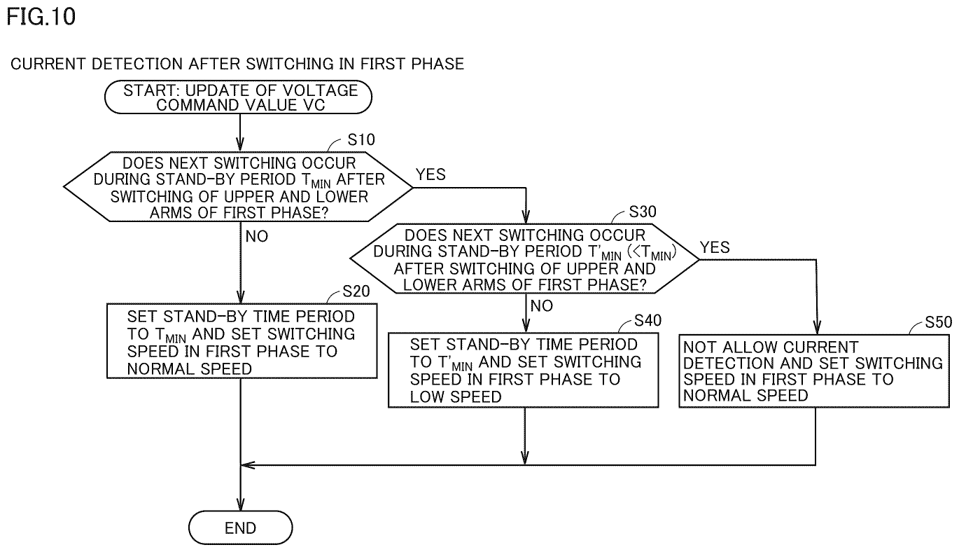

Drive capability adjuster 44 thus determines whether or not the current can be detected by reducing initially set normal stand-by time period T_{MIN} to T′_{MIN}. When the current can be detected by reduction of the stand-by time period, drive capability adjuster 44 adjusts drive capability to set the switching speed to be lower than a normal switching speed. Determination above is made and output of drive capability adjustment signal AS is provided each time voltage command value VC is updated based on timing of on and off of the drive signal estimated based on voltage command value VC and the durations of the on time period and the off time period. An operation by drive capability adjuster 44 performed each time voltage command value VC is updated will be described below with reference to FIG. 10.

FIG. 10 is a flowchart showing an operation by drive capability adjuster 44 in the power conversion device in the second embodiment. The flowchart in FIG. 10 shows the operation by drive capability adjuster 44 in current detection after switching of the upper arm and the lower arm of any first phase which is one of the U phase, the V phase, and the W phase.

Initially, in step S10, drive capability adjuster 44 determines whether or not next switching occurs during stand-by period T_{MIN} after switching of the upper and lower arms of the first phase, based on an estimated value of a time period before the switching state determined in accordance with voltage command value VC changes.

When drive capability adjuster 44 determines that next switching does not occur during initially set normal stand-by period T_{MIN} (NO in step S10), the process proceeds to step S20. In step S20, drive capability adjuster 44 sets the stand-by time period to normal stand-by time period T_{MIN} and outputs set stand-by time period T_{MIN} to current detection unit 40. Furthermore, drive capability adjuster 44 outputs drive capability adjustment signal AS to semiconductor driving units 23 in the upper and lower arms of the first phase such that switching of the upper and lower arms of the first phase is made at the initially set normal speed.

When drive capability adjuster 44 determines that next switching occurs during stand-by period T_{MIN} (YES in step S10), it determines in next step S30 whether or not next switching occurs during stand-by period T′_{MIN} after switching of the upper and lower arms of the first phase. Stand-by time period T′_{MIN} is a period shorter than T_{MIN}.

When drive capability adjuster 44 determines that next switching does not occur during stand-by period T′_{MIN} (NO in step S30), the process proceeds to step S40. In step S40, drive capability adjuster 44 sets the stand-by time period to shorter stand-by time period T′_{MIN} and outputs set stand-by time period T′_{MIN} to current detection unit 40. Furthermore, drive capability adjuster 44 outputs drive capability adjustment signal AS to semiconductor driving units 23 in the upper and lower arms of the first phase such that the switching speed of the upper and lower arms of the first phase is made at the low speed.

When drive capability adjuster 44 determines that next switching occurs during stand-by period T′_{MIN} (YES in step S30), the process proceeds to step S50. In step S50, drive capability adjuster 44 controls current detection unit 40 not to detect the current in the switching state after switching of the upper and lower arms of the first phase. Furthermore, drive capability adjuster 44 outputs drive capability adjustment signal AS to semiconductor driving units 23 in the upper and lower arms of the first phase such that the switching speed of the upper and lower arms of the first phase is made at the normal speed.

This is also applicable to current detection after switching of the upper arm and the lower arm of a second phase different from the first phase. A length of the stand-by time period and the switching speed are thus adjusted in accordance with a duration of the plurality of switching states in which the current is detected every cycle of the carrier signal.

### Effect of Second Embodiment

According to inverter device 10 as the power conversion device in the second embodiment, whether or not to set the stand-by time period to be shorter than the initially set value is determined in accordance with the duration of the switching state in which the current is detected. When the stand-by time period is to be reduced, drive capability is adjusted to set the switching speed to be lower than the initially set value in order to suppress influence by ringing. Since reduction of the stand-by time period and lowering of the switching speed are thus performed only when they are necessary for current detection, adverse influence such as increase in switching loss due to lowering in switching speed can be suppressed while the number of times of current detection is maintained as much as possible.

### Third Embodiment

In the third embodiment, the stand-by time period before current detection and the switching speed are adjusted based not only on timing of switching in each phase based on voltage command value VC but also on a polarity (positive and negative) of the output current of each phase detected and reconstructed by the current detection unit. Further detailed description will be given below with reference to the drawings.

### Exemplary Configuration of Main Controller 22A

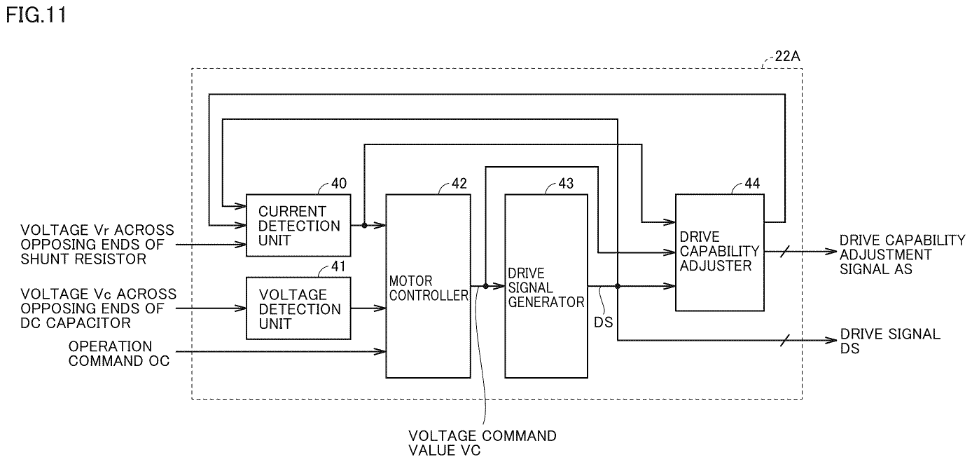

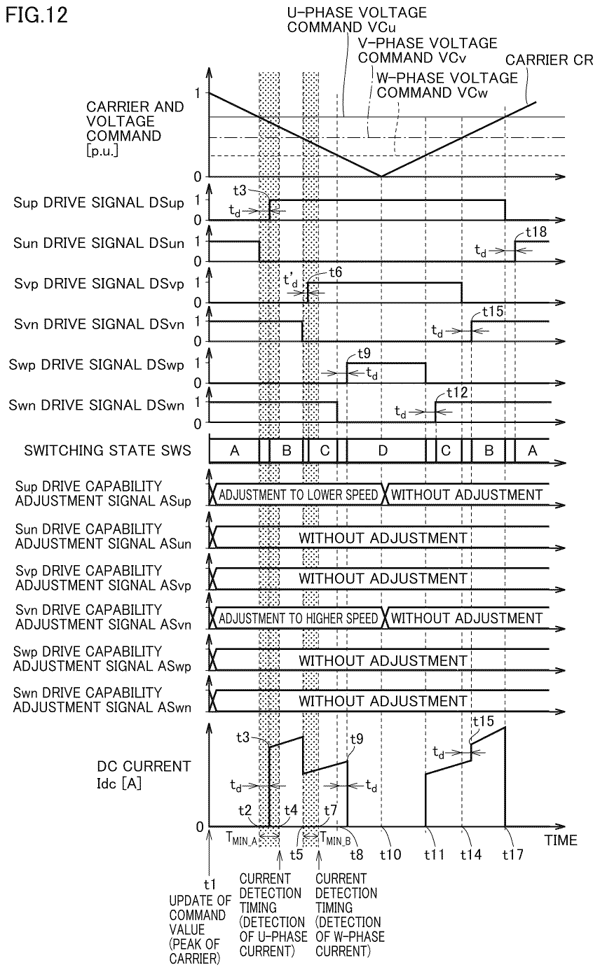

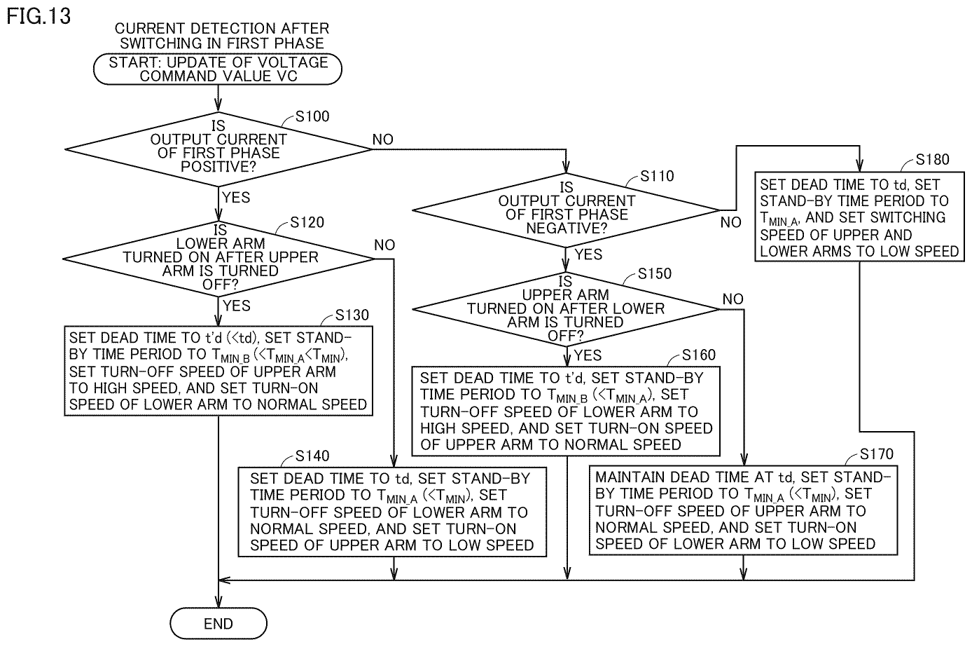

FIG. 11 is a block diagram showing an exemplary configuration 22A of a main controller in inverter device 10 as the power conversion device in the third embodiment. Main controller 22A in FIG. 11 is different from main controller 22 in FIG. 2 in that drive capability adjuster 44 further receives input of a value of a three-phase AC current reconstructed in current detection unit 40. Details of an operation by drive capability adjuster 44 in the third embodiment will be described later with reference to FIGS. 12 and 13.

Since FIG. 11 is otherwise similar to FIG. 2, identical or corresponding elements have identical reference characters allotted and description thereof will not be repeated. Since the third embodiment is otherwise similar in hardware configuration of the power conversion device to the first embodiment described with reference to FIGS. 1, 3, and 4, description will not be repeated.

### Details of Operation of Main Controller 22a

FIG. 12 is a timing chart showing an exemplary operation of main controller 22A in FIG. 11. The timing chart in FIG. 11 generally corresponds to the timing chart in FIG. 5, and shows drive signals DS for the upper arm and the lower arm of each phase in one cycle of a carrier, switching state SWS, drive capability adjustment signals AS for the upper arm and the lower arm of each phase, a waveform of a DC current, and current detection timing.

FIG. 5 shows drive signals DSu, DSv, and DSw of respective phases before the dead time is given, whereas FIG. 12 shows the drive signals for the upper arm and the lower arm of each phase after the dead time is given.

Drive capability adjustment signal AS for the upper arm and drive capability adjustment signal AS for the lower arm of an identical phase are identical to each other in FIG. 5, whereas drive capability adjustment signal AS for the upper arm and drive capability adjustment signal AS for the lower arm of the identical phase may be different from each other in FIG. 11. FIG. 11 shows a drive capability adjustment signal ASup corresponding to switching element Sup in the U-phase upper arm, a drive capability adjustment signal ASun corresponding to switching element Sun in the U-phase lower arm, a drive capability adjustment signal ASvp corresponding to switching element Svp in the V-phase upper arm, a drive capability adjustment signal ASvn corresponding to switching element Svn in the V-phase lower arm, a drive capability adjustment signal ASwp corresponding to switching element Swp in the W-phase upper arm, and a drive capability adjustment signal ASwnh corresponding to switching element Swn in the W-phase lower arm.

Switching states A to D in FIG. 12 are similar to those in FIG. 5 and correspond to (A) to (D) in FIG. 6, respectively. As in FIG. 6, the polarity of U-phase output current iu and W-phase output current iw is defined as positive and the polarity of the V-phase output current is defined as negative. The polarity of the output current is defined as positive when the output current flows in a direction from main circuit 20 of inverter device 10 to motor 13 and it is defined as negative when the output current flows in the reverse direction. Each switching element S is configured such that an IGBT and a freewheeling diode are connected in parallel.

A behavior of main circuit 20 such as switching of a current path and production of the recovery current or the like in response to switching of the switching state will be described below with reference to FIGS. 5 and 12. Furthermore, setting of appropriate stand-by time period and switching speed in consideration of the behavior of main circuit 20 will be described. As will be described below, the behavior of main circuit 20 changes in accordance with the polarity of the output current.

At time t2 in FIG. 12, switching element Sun in the U-phase lower arm is turned off. Transition from switching state A shown in FIG. 6(A) to the dead time in which switching element Sun in the U-phase lower arm is off is made. In this dead time, the current still keeps flowing to the freewheeling diode in the U-phase lower arm. Therefore, since ringing does not occur at the time of turn-off of the U-phase lower arm, drive capability of switching element Sun in the U-phase lower arm does not have to be adjusted.

At time t3 that follows, switching element Sup in the U-phase upper arm is turned on. Since transition to switching state B shown in FIG. 6(B) is thus made, the current that has flowed to the freewheeling diode in the U-phase lower arm is commutated to switching element Sup in the U-phase upper arm. Since the recovery current involved with this commutation is produced, ringing due to the recovery current occurs.

In order to suppress this ringing, drive capability adjuster 44 adjusts drive capability of switching element Sup to lower a turn-on speed of the U-phase upper arm. Furthermore, since ringing can be suppressed, the stand-by time period before current detection can be reduced from normal stand-by time period T_{MIN} to T_{MIN_A}. A specific value of stand-by time period T_{MIN_A} is set based on a result of tests or calculation performed in advance.

At time t4 after lapse of stand-by time period T_{MIN_A} since time t2, switching state B is maintained. At this time 14, current detection unit 40 detects the U-phase current.

At time t5 that follows, switching element Svn in the V-phase lower arm is turned off. Transition from switching state B shown in FIG. 6(B) to the dead time in which switching element Svn in the V-phase lower arm is off is thus made. As a result of turn-off of switching element Svn, the current that has flowed through switching element Svn in the V-phase lower arm is commutated to the freewheeling diode in the V-phase upper arm.

At time t6 that follows, switching element Svp in the V-phase upper arm is turned on. Though transition to switching state C shown in FIG. 6(C) is thus made, a forward current keeps flowing to the freewheeling diode in the V-phase upper arm before and after turn-on of switching element Svp. In such a case, no recovery current is produced, and ringing due to the recovery current does not occur either. In addition, delay in commutation due to the dead time does not occur either.

Thus, in switching of the upper and lower arms of the V-phase at time t5, 16, influence by ringing caused by the recovery current and the dead time can be avoided. Therefore, the stand-by time period can significantly be reduced to T_{MIN_B} (<T_{MIN_A}). In addition, by increasing the turn-off speed of the V-phase lower arm, the dead time can be reduced from an initially set normal dead time t_{d} to t′_{d}. A specific value of stand-by time period T_{MIN_B} is set based on a result of tests or calculation performed in advance. The turn-on speed of the V-phase upper arm may remain at the normal switching speed and drive capability does not have to be adjusted.

If the turn-off speed of the V-phase lower arm is increased, turn-off surge may become excessively large and a device may be damaged. Whether or not to adjust drive capability to increase a speed in this case is determined in advance in accordance with characteristics or the like of the circuit and the switching element.

Since subsequent operations of main controller 22 are similar to those in FIG. 5 in the first embodiment, identical or corresponding elements have identical reference characters allotted and description thereof will not be repeated.

FIG. 13 is a flowchart showing operations by drive capability adjuster 44 and drive signal generator 43 in the power conversion device in the third embodiment. The flowchart in FIG. 13 shows operations by drive capability adjuster 44 and drive signal generator 43 in current detection after switching of the upper arm and the lower arm of any first phase which is one of the U phase, the V phase, and the W phase.

Operations by drive capability adjuster 44 and drive signal generator 43 in FIG. 13 are performed at the time of and after update of voltage command value VC every cycle of the carrier signal, and determined by the switching state of each switching element based on voltage command value VC and the polarity of the output current.

In steps S100 and S110 in FIG. 13, whether the polarity of the output current of the first phase is positive (YES in step S100) or negative (YES in step S110) is determined.

In determination of the polarity of the current, a hysteresis width and a dead band are set. For example, a range of ±10% from a rated current is determined as the dead band (NO in each of steps S100 and S110). This is because the polarity of the current may change within one cycle of the carrier signal in a case of a motor large in change in current or in a case where the current is around zero where the polarity of the current tends to vary.

Initially, an example where the polarity of the output current of the first phase is positive (YES in step S100) and switching element S in the lower arm of the first phase is estimated to be turned on after turn-off of switching element S in the upper arm of the first phase based on voltage command value VC (YES in step S120) will be described. In this case, the current that flows through the first phase as a result of turn-off of switching element S in the upper arm is commutated from switching element S in the upper arm to the freewheeling diode in the lower arm. The current of the first phase keeps flowing to the freewheeling diode in the lower arm even when switching element S in the lower arm is turned on next. Therefore, ringing due to the recovery current does not occur.

Therefore, in next step S130, drive signal generator 43 sets the dead time to t′_{d} shorter than normal value t_{d}. Drive capability adjuster 44 sets the stand-by time period to shortest T_{MIN_B} (<T_{MIN_A} <T_{MIN}) and outputs set stand-by time period T_{MIN_B}to current detection unit 40. Furthermore, drive capability adjuster 44 outputs drive capability adjustment signal AS to semiconductor driving units 23 in the upper arm and the lower arm of the first phase such that the upper arm of the first phase is turned off at the high speed and the lower arm of the first phase is turned on at the normal speed.

When the polarity of the output current of the first phase is positive (YES in step S100) and switching element S in the upper arm of the first phase is estimated to be turned on after turn-off of switching element S in the lower arm of the first phase based on voltage command value VC (NO in step S120), on the other hand, the process proceeds to step S140. In this case, the current keeps flowing to the freewheeling diode in the lower arm even when switching element S in the lower arm is turned off. Thereafter, as a result of turn-on of switching element S in the upper arm, commutation from the freewheeling diode in the lower arm to switching element S in the upper arm occurs. Ringing due to the recovery current thus occurs. Therefore, influence by ringing should be suppressed.

Therefore, in step S140, drive signal generator 43 sets the dead time to normal value tₐ. Drive capability adjuster 44 sets the stand-by time period to T_{MIN_A} which is shorter than normal value T_{MIN} but longer than T_{MIN_B} and outputs set stand-by time period T_{MIN_A} to current detection unit 40. Furthermore, drive capability adjuster 44 outputs drive capability adjustment signal AS to semiconductor driving units 23 in the upper arm and the lower arm of the first phase such that the lower arm of the first phase is turned off at the normal speed and the upper arm of the first phase is turned on at the low speed.

An example where the polarity of the output current of the first phase is negative (YES in step S110) and switching element S in the upper arm of the first phase is estimated to be turned on after turn-off of switching element S in the lower arm of the first phase based on voltage command value VC (YES in step S150) will now be described. In this case, the current that flows through the first phase as a result of turn-off of switching element S in the lower arm is commutated from switching element S in the lower arm to the freewheeling diode in the upper arm. The current of the first phase keeps flowing to the freewheeling diode in the upper arm even when switching element S in the upper arm is turned on next. Therefore, ringing due to the recovery current does not occur.

Therefore, in next step S160, drive signal generator 43 sets the dead time to t′_{d} shorter than normal value t_{d}. Drive capability adjuster 44 sets the stand-by time period to shortest T_{MIN_B} (<T_{MIN_A}<T_{MIN}) and outputs set stand-by time period T_{MIN_B}to current detection unit 40. Furthermore, drive capability adjuster 44 outputs drive capability adjustment signal AS to semiconductor driving units 23 in the upper arm and the lower arm of the first phase such that the lower arm of the first phase is turned off at the high speed and the upper arm of the first phase is turned on at the normal speed.

When the polarity of the output current of the first phase is negative (YES in step S110) and switching element S in the lower arm of the first phase is estimated to be turned on after turn-off of switching element S in the upper arm of the first phase based on voltage command value VC (NO in step S150), on the other hand, the process proceeds to step S170. In this case, the current keeps flowing to the freewheeling diode in the upper arm even when switching element S in the upper arm is turned off. Thereafter, as a result of turn-on of switching element S in the lower arm, commutation from the freewheeling diode in the upper arm to switching element S in the lower arm occurs. Ringing due to the recovery current thus occurs. Therefore, influence by ringing should be suppressed.

Therefore, in step S170, drive signal generator 43 sets the dead time to normal value t_{d}. Drive capability adjuster 44 sets the stand-by time period to T_{MIN_A} which is shorter than normal value T_{MIN} but longer than T_{MIN_B} and outputs set stand-by time period T_{MIN_A} to current detection unit 40. Furthermore, drive capability adjuster 44 outputs drive capability adjustment signal AS to semiconductor driving units 23 in the upper arm and the lower arm of the first phase such that the upper arm of the first phase is turned off at the normal speed and the lower arm of the first phase is turned on at the low speed.

An example of the dead band where the output current of the first phase can be determined as neither of positive and negative polarities (NO in each of steps S100 and S110) will now be described. In this case, in step S180, main controller 22 carries out control as in the first embodiment. Specifically, drive signal generator 43 sets the dead time to normal value t_{d}. Drive capability adjuster 44 sets the stand-by time period to T_{MIN_A} which is shorter than normal value T_{MIN} but longer than T_{MIN_B} and outputs set stand-by time period T_{MIN_A} to current detection unit 40. Furthermore, drive capability adjuster 44 outputs drive capability adjustment signal AS to semiconductor driving units 23 in the upper arm and the lower arm of the first phase such that switching of the upper arm and the lower arm is made at the low speed.

Alternatively, drive signal generator 43 may set the dead time to normal value to and drive capability adjuster 44 may not adjust drive capability, by maintaining the stand-by time period at initially set normal value T_{MIN}.

### Effect of Third Embodiment

As set forth above, according to the power conversion device in the third embodiment, the stand-by time period for current detection, drive capability of switching element S, and the dead time are adjusted based on the polarity of the output current in addition to the switching state of main circuit 20 based on voltage command value VC. The stand-by time period can thus further be reduced and the number of elements drive capability of which is to be adjusted can be reduced. Therefore, while increase in switching loss is suppressed as much as possible, an operation range where the current can be detected can be larger and control characteristics of the motor can be improved.

The third embodiment may be combined with the second embodiment. In other words, when the current can be detected without reduction of the stand-by time period and drive capability adjustment, they do not have to be performed.

It should be understood that the embodiments disclosed herein are illustrative and non-restrictive in every respect. The scope of this application is defined by the terms of the claims rather than the description above and is intended to include any modifications within the scope and meaning equivalent to the terms of the claims,

### REFERENCE SIGNS LIST

10 inverter device (power conversion device); 11 AC power supply; 12 converter circuit; 13 motor; 20 main circuit (power converter); 21 control device; 22, 22A main controller; 23 semiconductor driving unit; 24 DC capacitor; 25 shunt resistor (current sensor); 31 high-potential-side output node; 32 low-potential-side output node; 33 high-potential-side DC bus; 34 low-potential-side DC bus; 35, 36, 37 output node; 40 current detection unit; 41 voltage detection unit; 42 motor controller; 43 drive signal generator; 44 drive capability adjuster; 50, 59 drive circuit; 51 resistance value adjustment circuit; 52 N-type bipolar transistor; 53 P-type bipolar transistor; 54 resistive element; 55 switch; 56 drive voltage adjustment circuit; 57 voltage amplifier; 58 drive circuit controller; 60, 61 MOSFET; AS drive capability adjustment signal; CR carrier signal; DS drive signal; Ic collector current; Ide DC current; OC operation command; T_{MIN}, I′_{MIN}, T_{MIN_A}, T_{MIN_B} delay time period; VC voltage command value; Vdc DC voltage; iu, iv, iw output current; t_{d}, t′_{d} dead time.

1. A control device for a power converter, the power converter comprising a plurality of switching elements, the power converter converting power by switching of the plurality of switching elements, the control device comprising:
a current sensor to detect a current that flows through the plurality of switching elements;
a plurality of semiconductor driving units, each of the plurality of semiconductor driving units being provided for a corresponding switching element of the plurality of switching elements and adjusting a switching speed of the corresponding switching element in accordance with a corresponding drive capability adjustment signal; and
a main controller to output a drive signal for controlling timing of switching to each of the plurality of switching elements based on a value of current detection by the current sensor, wherein
the main controller generates, for each of the semiconductor driving units, the corresponding drive capability adjustment signal based on relation between timing of switching of the corresponding switching element and timing of current detection by the current sensor.

2. The control device for a power converter according to claim 1, wherein
when the main controller generates the drive capability adjustment signal to change the switching speed of a first switching element of the plurality of switching elements from an initially set value to a low speed, the main controller sets a time period from switching of the first switching element until current detection by the current sensor to be shorter than the initially set value.

3. The control device for a power converter according to claim 1, wherein
when the main controller generates the drive capability adjustment signal to change the switching speed of a second switching element of the plurality of switching elements from an initially set value to a high speed, the main controller sets a time period from switching of the second switching element until current detection by the current sensor to be shorter than the initially set value.

4. The control device for a power converter according to claim 1, wherein
the power converter is an inverter circuit to convert DC power supplied from a DC bus to three-phase AC power and to output three-phase AC power to a motor,
the power converter comprises:
a high-potential-side DC bus;
a low-potential-side DC bus; and
a switching element in an upper arm and a switching element in a lower arm corresponding to each phase of the three-phase AC power, the switching element in the upper arm and the switching element in the lower arm being connected in series between the high-potential-side DC bus and the low-potential-side DC bus,
the current sensor is provided in the high-potential-side DC bus or the low-potential-side DC bus, and
the main controller reconstructs a three-phase current that flows between the power converter and the motor based on the current detected in a plurality of switching states of the plurality of switching elements and outputs the drive signal corresponding to each of the plurality of switching elements based on the reconstructed three-phase current.

5. The control device for a power converter according to claim 4, wherein
in current detection by the current sensor in a switching state after switching of the upper arm and the lower arm of a first phase of three phases, when next switching is expected to occur during a stand-by period until current detection even when a switching speed of the upper arm and the lower arm of the first phase is changed to a speed lower than an initially set value and the stand-by period is set to be shorter than an initially set value, the main controller maintains the switching speed at the initially set value, maintains the stand-by period at the initially set value, and does not detect the current.

6. The control device for a power converter according to claim 4, wherein
in current detection by the current sensor in a switching state after switching of the upper arm and the lower arm of a first phase of three phases, when next switching is not expected to occur during a stand-by period until current detection even when a switching speed of the upper arm and the lower arm of the first phase is maintained at an initially set value and the stand-by period is maintained at an initially set value, the main controller detects the current with the switching speed being maintained at the initially set value and with the stand-by period being maintained at the initially set value.

7. The control device for a power converter according to claim 4, wherein
in current detection by the current sensor in a switching state after switching of the upper arm and the lower arm of a first phase of three phases, the main controller changes a switching speed of the switching element in one of the upper arm and the lower arm of the first phase from an initially set value and does not change the switching speed of the other switching element from the initially set value, in accordance with a polarity of a current of the first phase that flows between the power converter and the motor.

8. The control device for a power converter according to claim 7, wherein
in turn-on of the switching element in the lower arm of the first phase after turn-off of the switching element in the upper arm of the first phase while the current of the first phase is outputted from the power converter in a direction toward the motor, the main controller sets a dead time from turn-off of the upper arm of the first phase until turn-on of the lower arm of the first phase to be shorter than an initially set value and sets the switching speed of the upper arm of the first phase to a speed higher than the initially set value.

9. The control device for a power converter according to claim 7, wherein
in turn-on of the switching element in the upper arm of the first phase after turn-off of the switching element in the lower arm of the first phase while the current of the first phase is inputted from the motor in a direction toward the power converter, the main controller sets a dead time from turn-off of the lower arm of the first phase until turn-on of the upper arm of the first phase to be shorter than an initially set value and sets the switching speed of the lower arm of the first phase to a speed higher than the initially set value.

10. A power conversion device comprising:
the control device according claim 1; and
a power converter comprising a plurality of switching elements, the power converter converting power by switching of the plurality of switching elements.
